(19) United States
(12) Patent Application Publication
(10) Pub. No.: US 2018/0254449 A1
(43) Pub. Date: Sep. 6, 2018

(54) COMPOSITE POROUS SEPARATOR INCLUDING LITHIUM ION-EXCHANGED ZEOLITE PARTICLES

(71) Applicant: GM GLOBAL TECHNOLOGY OPERATIONS LLC, Detroit, MI (US)

(72) Inventors: Xingcheng Xiao, Troy, MI (US); Jiagang Xu, Warren, MI (US); Sherman H. Zeng, Troy, MI (US); Mei Cai, Bloomfield Hills, MI (US); Mark W. Verbrugge, Troy, MI (US)

(21) Appl. No.: 15/709,752

(22) Filed: Sep. 20, 2017

Related U.S. Application Data
(63) Continuation-in-part of application No. 15/447,355, filed on Mar. 2, 2017.

(51) Int. Cl. H01M 2/16; H01M 2/14; H01M 10/0525

(52) U.S. Cl. CPC H01M 2/1646; H01M 2/145; H01M 10/0525; H01M 2/1653; H01M 2/1686

(57) ABSTRACT

A composite porous separator for an electrochemical cell of a secondary lithium ion battery includes particles of a lithium ion-exchanged zeolite material. The composite porous separator may be manufactured by preparing a slurry comprising a polymeric binder material and the particles of the lithium ion-exchanged zeolite material, and then depositing the slurry on one or more sides of a porous substrate. Thereafter, the slurry may be dried to form a solid microporous active layer on the one or more sides of the substrate.

### CROSS-REFERENCE TO RELATED APPLICATION

This application is a continuation-in-part of Ser. No. 15/447,355 filed on Mar. 2, 2017, the complete contents of which are herein incorporated by reference.

### TECHNICAL FIELD

The present disclosure relates generally to lithium ion batteries and, more specifically, to composite microporous polymeric separators for lithium ion batteries.

### INTRODUCTION

A battery is a device that converts chemical energy into electrical energy by means of electrochemical reduction-oxidation (redox) reactions. In secondary or rechargeable batteries, these electrochemical reactions are reversible, which allows the batteries to undergo multiple charging and discharge cycles.

Secondary lithium ion batteries generally include one or more electrochemical cells having a negative electrode, a positive electrode, and an electrolyte for conducting lithium ions between the negative and positive electrodes. A porous separator wetted with a liquid electrolyte solution may be sandwiched between the electrodes to physically separate and electrically insulate the electrodes from each other while permitting free ion flow. Each of the negative and positive electrodes is typically carried on or connected to a metallic current collector, for example, in the form of a thin layer of electrode material. The current collectors may be connected to each other by an interruptible external circuit through which electrons can pass from one electrode to the other while lithium ions migrate in the opposite direction through the electrochemical cell during charging and discharge of the battery.

The positive electrode in a lithium ion battery typically comprises a lithium-based intercalation host material that can undergo the reversible insertion or intercalation of lithium ions. The negative electrode typically comprises an intercalation host material that can undergo the reversible insertion or intercalation of lithium ions at a lower electrochemical potential than the material of the positive electrode such that an electrochemical potential difference exists between the electrodes. The electrolyte comprises a material suitable for conducting lithium ions and may be in solid or liquid form. A suitable non-aqueous liquid electrolyte may comprise a solution including a lithium salt dissolved or ionized in an organic solvent or a mixture of organic solvents. In such case, the porous separator may comprise a thin polymeric membrane interposed between facing surfaces of the positive and negative electrodes layers.

Lithium ion batteries can reversibly supply power to an associated load device on demand. More specifically, electrical power can be supplied to a load device by a lithium ion battery until the lithium content of the negative electrode is effectively depleted. The battery may then be recharged by passing a suitable direct electrical current in the opposite direction between the electrodes.

During discharge, the negative electrode contains a relatively high concentration of intercalated lithium, which is oxidized into lithium ions and electrons. The lithium ions travel from the negative electrode (anode) to the positive electrode (cathode), for example, through the ionically conductive electrolyte solution contained within the pores of the interposed porous polymeric separator. At the same time, the electrons pass through the external circuit from the negative electrode to the positive electrode. The lithium ions are assimilated into the material of the positive electrode by an electrochemical reduction reaction. The battery may be recharged after a partial or full discharge of its available capacity by an external power source, which reverses the electrochemical reactions that transpired during discharge.

During re-charge, intercalated lithium in the positive electrode is oxidized into lithium ions and electrons. The lithium ions travel from the positive electrode to the negative electrode through the porous separator via the electrolyte, and the electrons pass through the external circuit to the negative electrode. The lithium cations are reduced to elemental lithium at the negative electrode and stored in the material of the negative electrode for reuse.

### SUMMARY

A method for manufacturing a composite porous separator for an electrochemical cell of a secondary lithium ion battery. A slurry may be prepared comprising particles of a lithium ion-exchanged zeolite material and a polymeric binder material. A porous separator may be provided having a first side and an opposite second side. The slurry may be deposited on the first or second side of the substrate. Then, the slurry may be dried on the substrate to form a solid microporous active layer on the first or second side of the substrate.

The porous substrate may comprise a microporous polyolefin-based membrane.

The polymeric binder material may be formed from a two-component polymeric binder system including a polymer precursor component and a crosslinking component. The polymer precursor component may comprise at least one polymer or polymer precursor selected from the group consisting of: sodium ammonium alginate, polyvinyl alcohol, polyacrylic acid, carboxymethyl cellulose, styrene-butadiene rubber, fluorine-acrylic hybrid latex, and combinations thereof. The crosslinking component may comprise dimethylol urea, melamine formaldehyde resin, polyamide-epichlorohydrin (PAE) resin, N-(1-hydroxy-2,2-dimethoxyethyl)acrylamide, N,N′-methylenebisacrylamide, ethylene glycol dimethacrylate, and combinations thereof.

The particles of the lithium ion-exchanged zeolite material are present in the slurry in an amount in the range of 10 wt. % to 30 wt. %.

The polymeric binder material is present in the slurry in an amount in the range of 1.5 wt. % to 8 wt. %.

The slurry may be dried by heating the substrate at a temperature in the range of about 30° C. to about 140° C. for about 3 minutes to about 2 hours.

The slurry may have a viscosity in the range 400-1200 mPa·s when the slurry is deposited on the first or second side of the substrate.

The particles of the lithium ion-exchanged zeolite material may comprise particles of a dehydrated zeolite material exhibiting an Si:Al ratio in the range of 1:1 to 2:1 and having a framework type selected from the group consisting of: ABW, AFG, ANA, BIK, CAN, EDI, FAU, FRA, GIS, GME, JBW, LAU, LEV, LIO, LOS, LTA, LTN, NAT, PAR, PHI, ROG, SOD, WEN, THO, and TSC.

The particles of the lithium ion-exchanged zeolite material may comprise particles of a dehydrated zeolite material exhibiting an Si:Al ratio in the range of 2:1 to 5:1 and having a framework type selected from the group consisting of: BHP, BOG, BRE, CAS, CHA, CHI, DAC, EAB, EMT, EPI, ERI, FAU, FER, GOO, HEU, KFI, LOV, LTA, LTL, MAZ, MEI, MER, MON, MOR, OFF, PAU, RHO, SOD, STI, and YUG.

The particles of the lithium ion-exchanged zeolite material may comprise particles of a dehydrated zeolite material exhibiting an Si:Al ratio of greater than 5:1 and having a framework type selected from the group consisting of: ASV, BEA, CFI, CON, DDR, DOH, DON, ESV, EUO, FER, GON, IFR, ISV, ITE, LEV, MEL, MEP, MFI, MFS, MSO, MTF, MTN, MTT, MTW, MWW, NON, NES, RSN, RTE, RTH, RUT, SFE, SFF, SGT, SOD, STF, STT, TER, TON, VET, VNI, and VSV.

An electrochemical cell for a secondary lithium ion battery may comprise a negative electrode layer, a positive electrode layer, a composite porous separator, and a liquid electrolyte. The positive electrode layer may be spaced apart from the negative electrode layer. The composite porous separator layer may be disposed between confronting surfaces of the negative electrode layer and the positive electrode layer. The liquid electrolyte may infiltrate the negative electrode layer, the positive electrode layer, and the porous separator layer

The porous substrate may include a first side that faces toward the negative electrode layer and an opposite second side that faces toward the positive electrode layer. In one form, the solid microporous active layer may be formed on the first or second side of the porous substrate. In another form, a first solid microporous active layer may be formed on the first side of the porous substrate and a second solid microporous active layer may be formed on the second side of the porous substrate.

The particles of the lithium ion-exchanged zeolite material may be present in the solid microporous active layer in an amount in the range of 20 wt. % to 95 wt. %.

A secondary lithium ion battery may include a plurality of the electrochemical cells. The electrochemical cells may be connected in a series or parallel arrangement.

### BRIEF DESCRIPTION OF THE DRAWINGS

FIG. 1 is a cross-sectional view of an electrochemical cell of a lithium ion battery along with its associated metallic current collectors according to one aspect of the disclosure;

FIG. 2 is an exploded cross-sectional view of the electrochemical cell of FIG. 1;

FIG. 3 is a partial perspective view of a lithium ion battery including a plurality of stacked electrochemical cells according to one aspect of the disclosure;

FIG. 4 is a graph of Specific Capacity (mAh/cm²) vs. Cycle Number depicting the specific capacity of three electrochemical cells for a lithium ion battery, wherein the electrochemical cells respectively include (i) an alumina-coated polyethylene separator (60), (ii) a tri-layer polypropylene and polyethylene (PP/PE/PP) separator (62), and (iii) a tri-layer PP/PE/PP separator having active layers including particles of a lithium ion-exchanged zeolite material formed on opposite first and second sides thereof (64); and

FIG. 5 is a graph of Coulombic Efficiency (%) vs. Cycle Number depicting the efficiency of three electrochemical cells for a lithium ion battery, wherein the electrochemical cells respectively include (i) an alumina-coated polyethylene separator (70), (ii) a tri-layer polypropylene and polyethylene (PP/PE/PP) separator (72), and (iii) a tri-layer PP/PE/PP separator having active layers including particles of a lithium ion-exchanged zeolite material formed on opposite first and second sides thereof (74).

### DETAILED DESCRIPTION

A composite porous separator is manufactured by coating, depositing, or otherwise forming active layers including particles of a lithium ion-exchanged zeolite material on opposite sides of a porous substrate. When assembled in an electrochemical cell of a lithium ion battery, the composite porous separator is infiltrated with a liquid electrolyte and the particles of the lithium ion-exchanged zeolite material actively remove trace water, hydrogen ions, hydrofluoric acid, dissociated transition metal ions (e.g., Mn²⁺ and Fe^{2+/3+} ions), and other target compounds from the liquid electrolyte without inhibiting the transport or net flow of lithium ions therethrough. The removal of these target compounds from the liquid electrolyte during operation of the battery can, in turn, help prevent or mitigate degradation of various battery components and thereby improve the life and cycle performance of the battery.

As used herein, the term “lithium ion-exchanged zeolite material” means a zeolite that has been ion-exchanged with lithium ions such that a plurality of lithium ions are present within the zeolite as free ions and/or as extra-framework ions.

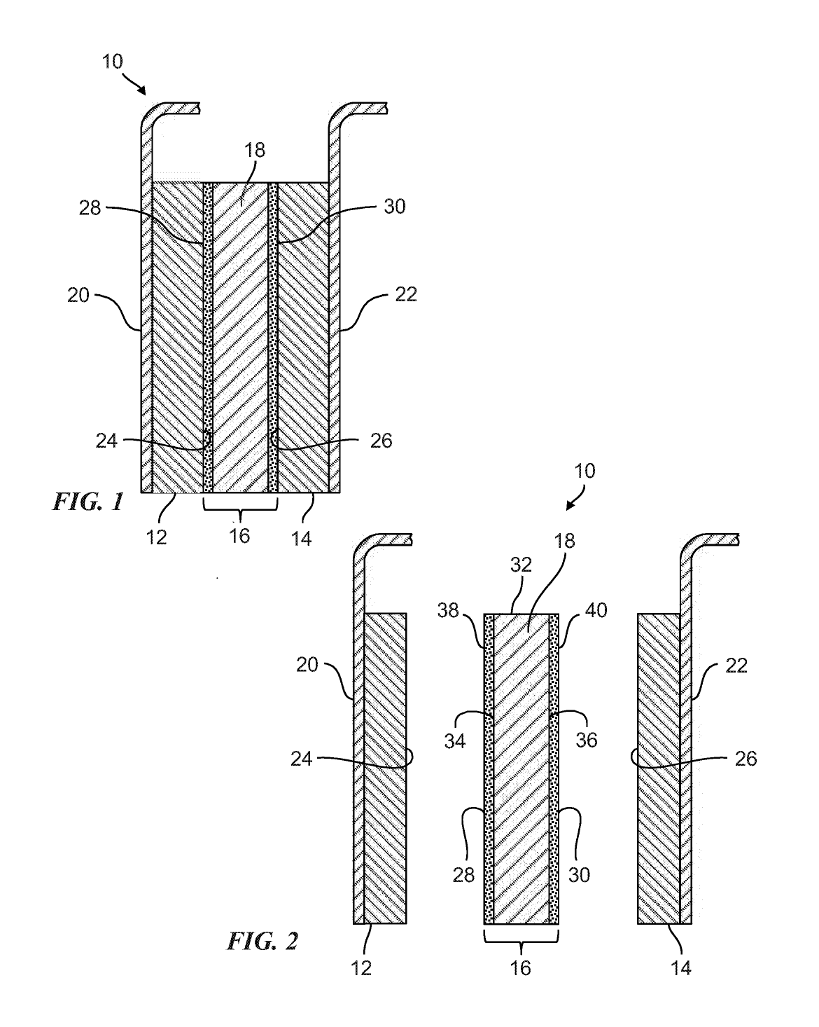

FIGS. 1 and 2 illustrate in idealized fashion an electrochemical cell 10 of a lithium ion battery (not shown) that includes particles of a lithium ion-exchanged zeolite material disposed within a lithium ion transport path through the electrochemical cell 10. The electrochemical cell 10 comprises a negative electrode layer 12, a positive electrode layer 14, a composite porous separator layer 16, and a liquid electrolyte 18 that impregnates, infiltrates, or wets the surfaces of and fills the pores of each of the layers 12, 14, 16. A negative electrode current collector 20 is positioned adjacent and electrically coupled to the negative electrode layer 12, and a positive electrode current collector 22 is positioned adjacent and electrically coupled to the positive electrode layer 14.

The negative and positive electrode layers 12, 14 may be coated, deposited, or otherwise formed on opposing major surfaces of the negative and positive electrode current collectors 20, 22, with the negative and positive electrode layers 12, 14 respectively having opposing, confronting first and second faces 24, 26. As shown in FIG. 1, in assembly, the porous separator layer 16 is sandwiched between the first and second faces 24, 26 of the negative and positive electrode layers 12, 14, with the separator layer 16 including a first side 28 that faces toward and presses against the first face 24 of the negative electrode layer 12 and a second side 30 that faces toward and presses against the second face 26 of the positive electrode layer 14.

The electrochemical cell 10 may have a thickness, measured from an outer surface of the negative electrode current collector 20 to an opposite outer surface of the positive electrode current collector 22 in the range of about 100 micrometers to about one millimeter. Individually, the current collectors 20, 22 may have thicknesses of about 20 micrometers, the electrode layers 12, 14 may have thicknesses of up to 200 micrometers, and the separator layer 16 may have a thickness of about 25 micrometers.

The negative electrode layer 12 may comprise any material that can undergo the reversible insertion or intercalation of lithium ions at a lower electrochemical potential than the material of the positive electrode layer 14 such that an electrochemical potential difference exists between the electrode layers 12, 14. The material of the negative electrode layer 12 may be generally described as an intercalation host material. Some examples of suitable intercalation host materials for the negative electrode layer 12 include carbon-based materials (e.g., graphite, activated carbon, carbon black, and graphene), lithium, lithium-based materials, silicon, silicon-based alloys or composite materials, tin oxide, aluminum, indium, zinc, germanium, silicon oxide, titanium oxide, lithium titanate, and combinations thereof. The intercalation host material of the negative electrode layer 12 may be intermingled with a polymeric binder to provide the negative electrode layer 12 with structural integrity. Some examples of suitable polymeric binders include polyvinylidene fluoride (PVdF), ethylene propylene diene monomer (EPDM) rubber, styrene butadiene rubber (SBR), carboxymethyl cellulose (CMC), polyacrylic acid, and mixtures thereof. The negative electrode layer 12 optionally may include particles of an electrically conductive material, which may comprise very fine particles of, for example, high-surface area carbon black.

The positive electrode layer 14 may comprise any material that can undergo the reversible insertion or intercalation of lithium ions. In one form, the positive electrode layer 14 comprises a lithium-based intercalation host material having a higher electrochemical potential than the intercalation host material of the negative electrode layer 12. The intercalation host material of the positive electrode layer 14 suitably may comprise a layered oxide represented by the formula LiMeO₂, an olivine-type oxide represented by the formula LiMePO₄, a spinel-type oxide represented by the formula LiMe₂O₄, or a combination thereof, where Me is a transition metal. Some examples of suitable transition metals for the metal oxide of the intercalation host material of the positive electrode layer 14 include Co, Ni, Mn, Fe, Al, V, and combinations thereof. More specifically, the lithium-based intercalation host material may comprise a layered lithium transition metal oxide, such as lithium cobalt oxide (LiCoO₂) and lithium-nickel-manganese-cobalt oxide [Li(Ni_{X}Mn_{Y}Co_{Z})O₂], a spinel lithium transition metal oxide, such as spinel lithium manganese oxide (LiMn₂O₄), lithium iron phosphate (LiFePO₄), or lithium fluorophosphate (Li₂FePO₄F), lithium nickel oxide (LiNiO₂), lithium aluminum manganese oxide (Li_{X}Al_{Y}Mn_{1-Y}O₂), lithium vanadium oxide (LiV₂O₅), or a combination thereof. The same polymeric binder materials (PVdF, EPDM, SBR, CMC, polyacrylic acid) and electrically conductive particles (high-surface area carbon black) used in the negative electrode layer 12 also may be intermingled with the lithium-based intercalation host material of the positive electrode layer 14 for the same purposes.

The liquid electrolyte 18 may comprise any material that is capable of effectively conducting lithium ions through the separator layer 16 and between the negative and positive electrodes 12, 14. For example, the liquid electrolyte 18 may comprise a non-aqueous liquid electrolyte. In such case, the liquid electrolyte 18 may comprise a solution including a lithium salt dissolved or ionized in a nonaqueous, aprotic organic solvent or a mixture of nonaqueous, aprotic organic solvents. Some suitable lithium salts that may be used to make the electrolyte 18 include LiClO₄, LiAlCl₄, LiI, LiBr, LiSCN, LiBF₄, LiB(C₆H₅)₄, LiAsF₆, LiCF₃SO₃, LiN(CF₃SO₂)₂, LiPF₆, and combinations thereof. The nonaqueous, aprotic organic solvent in which the lithium salt is dissolved may be a cyclic carbonate (i.e., ethylene carbonate, propylene carbonate), an acyclic carbonate (i.e., dimethyl carbonate, diethyl carbonate, ethyl methyl carbonate), an aliphatic carboxylic ester (i.e., methyl formate, methyl acetate, methyl propionate), a γ-lactone (i.e., γ-butyrolactone, γ-valerolactone), an acyclic ether (i.e., 1,2-dimethoxyethane, 1,2-diethoxyethane, ethoxymethoxyethane), a cyclic ether (i.e., tetrahydrofuran, 2-methyltetrahydrofuran), or a combination thereof.

The negative and positive electrode current collectors 20, 22 respectively associated with the negative and positive electrode layers 12, 14 may comprise any metallic material capable of collecting and reversibly passing free electrons to and from their respective electrode layers 12, 14. For example, the negative and positive electrode current collectors 20, 22 may comprise thin and flexible metallic foils. In one specific example, the positive electrode current collector 22 may comprise aluminum, nickel, or stainless steel foils and the negative electrode current collector 20 may comprise copper, nickel, stainless steel, or titanium foils. Other types of metal foils or metallic materials may of course be used, if desired.

As shown in FIG. 2, the composite porous separator layer 16 includes a porous substrate 32 having a first side 34 that faces toward the first face 24 of the negative electrode layer 12 and a second side 36 that faces toward the second face 26 of the positive electrode layer 14. One or both sides 34, 36 of the substrate 32 are coated with a solid microporous active layer that includes particles of a lithium ion-exchanged zeolite material. In the embodiment depicted in FIGS. 1 and 2, the first side 34 of the substrate 32 is coated with a first active layer 38 and the second side 36 of the substrate 32 is coated with a second active layer 40. In assembly, the first active layer 38 faces toward and presses against the first face 24 of the negative electrode layer 12 and the second active layer 40 faces toward and presses against the second face 26 of the positive electrode layer 14. However, in other embodiments, the first side 34 of the substrate 32 may be coated with the first active layer 38 and the second side 36 of the substrate 32 may be uncoated such that, in assembly, the second side 36 of the substrate 32 faces toward and presses against the second face 26 of the positive electrode layer 14. In addition, in other embodiments, the second side 36 of the substrate 32 may be coated with the second active layer 40 and the first side 34 of the substrate 32 may be uncoated such that, in assembly, the first side 34 of the substrate 32 faces toward and presses against the first face 24 of the negative electrode layer 12.

The first and second active layers 38, 40 may be continuously or discontinuously formed on the first and second sides 34, 36 of the substrate 32. For example, the first active layer 38 may be formed on the first side 34 of the substrate 32 such that the active layer 38 covers an entire surface area or only a portion of the surface area on the first side 34 of the substrate 32 that faces toward the first face 24 of the negative electrode layer 12. Likewise, the second active layer 40 may be formed on the second side 36 of the substrate 32 such that the active layer 40 covers an entire surface area or only a portion of the surface area on the second side 36 of the substrate 32 that faces toward the second face 26 of the positive electrode layer 14. The active layers 38, 40 may extend over the first and second sides 34, 36 of the substrate 32 and, in some instances, may extend partway into the micropores of the substrate 32.

The porous substrate 32 may comprise any organic or inorganic material that can physically separate and electrically insulate the layers 12, 14 from each other while permitting the free flow of lithium ions therebetween. For example, the substrate 32 may comprise a non-woven material, e.g., a manufactured sheet, web, or matt of directionally or randomly oriented fibers. As another example, the substrate 32 may comprise a microporous polymeric material, e.g., a microporous polyolefin-based membrane or film. The porous substrate 32 may comprise a single polyolefin or a combination of polyolefins, such as polyethylene (PE), polypropylene (PP), polyamide (PA), poly(tetrafluoroethylene) (PTFE), polyvinylidene fluoride (PVdF), and/or poly(vinyl chloride) (PVC). In one form, the porous substrate 32 may comprise a laminate of one or more polymeric materials, such as a laminate of PE and PP. The substrate 32 may have a thickness, measured between the first and second sides 34, 36 of the substrate 32, in the range of 10 μm to 30 μm.

The first and second active layers 38, 40 comprise particles of a lithium ion-exchanged zeolite material and may be formed on the first and/or second sides 34, 36 of the substrate 32 by coating or otherwise depositing a mixture (referred to herein as a “slurry”) including the particles of the lithium ion-exchanged zeolite material and a polymeric binder material on the first and/or second sides 34, 36 of the substrate 32, and then drying the slurry. At the time the slurry is deposited on the first and/or second sides 34, 36 of the substrate 32, the slurry may have a viscosity in the range 400-1200 mPa·s and may be at a temperature of about 25° C.

The particles of the lithium ion-exchanged zeolite material may be present in the slurry in an amount ranging from about 10 wt. % to about 30 wt. %. The particles of the lithium ion-exchanged zeolite material may be present in the first and/or second active layers 38, 40 in an amount ranging from about 20 wt. % to about 95 wt. %.

The polymeric binder material may be present in the slurry in an amount ranging from about 1.5 wt. % to about 8 wt. %. The polymeric binder material may be present in the first and/or second active layers 38, 40 in an amount ranging from about 5 wt. % to about 80 wt. %.

The mass ratio of the particles of the lithium ion-exchanged zeolite material to the polymeric binder material in the slurry may be in the range of about 20:1 to about 5:4. For example, the mass ratio of the particles of the lithium ion-exchanged zeolite material to the polymeric binder material in the slurry may be about 20:3.

The polymeric binder material may comprise any material that comprises or contains a polymer and may include composite materials that include a combination of a polymer and a non-polymeric material. The term “polymer” is used in its broad sense to denote both homopolymers and heteropolymers. Homopolymers are made of a single type of polymer, while heteropolymers (also known as copolymers) are made of two (or more) different types of monomers. In one form, the polymeric binder material may be formed from a two-component polymeric binder system that includes a polymer precursor component and a crosslinking component. In such case, the slurry may be prepared by a process that includes the following general steps: (1) providing a polymer precursor component including a polymer or polymer precursor (e.g., monomer or oligomer) dissolved or homogenously dispersed in a solvent, (2) mixing particles of a lithium ion-exchanged zeolite material in the polymer precursor component to form an intermediate mixture, and then (3) mixing a crosslinking component into the intermediate mixture to form the slurry. The intermediate mixture may have a viscosity in the range 400-1200 mPa·s at a temperature of about 25° C. When the polymer precursor component and the crosslinking component are combined during formation of the slurry, a chemical reaction referred to as polymerization occurs between the components which causes the components to bind together (e.g., by the formation of stable covalent bonds) to form crosslinked networks known as polymers. The mass ratio of the polymer precursor component to the crosslinking component may be in the range of about 10:1 to about 5:1. For example, the mass ratio of the polymer precursor component to the crosslinking component may be about 9:1.

Additional solvent may be added to the polymer precursor component and/or the intermediate mixture to control or adjust the viscosity and/or the thixotropic or rheological properties of the slurry prior to addition of the crosslinking component. Some specific examples of suitable aqueous and non-aqueous solvents that may be included in or added to the polymer precursor component and/or the intermediate mixture include: water, N-methyl-2-pyrrolidone (NMP), toluene, and combinations thereof.

Some specific examples of suitable polymer precursor components include: alginate (e.g., sodium and/or ammonium alginate), polyvinyl alcohol (PVA), polyacrylic acid (PAA), carboxymethyl cellulose (CMC), styrene-butadiene rubber (SBR), fluorine-acrylic hybrid latex, and combinations thereof.

The crosslinking component may comprise a polymeric material or a non-polymeric material. For example, the crosslinking component may comprise a polymer or polymer precursor (e.g., monomer or oligomer). Some specific examples of suitable crosslinking components include: dimethylol urea, melamine formaldehyde resin, polyamide-epichlorohydrin (PAE) resin, N-(1-hydroxy-2,2-dimethoxyethyl)acrylamide, N,N′-methylenebisacrylamide, ethylene glycol dimethacrylate, and combinations thereof.

The slurry may be coated or otherwise applied to the first and/or second sides 34, 36 of the substrate 32 by any suitable method. For example, the slurry may be spread or cast onto the first and/or second sides 34, 36 of the substrate 32. Thereafter the slurry may be dried to remove the solvent and to complete the crosslinking or polymerization reaction by heating the substrate 32 at a temperature in the range of about 30° C. to about 140° C. for about 3 minutes to about 2 hours. In one specific example, the slurry may be dried by heating the substrate 32 at a temperature of about 80° C. for about 3 minutes. Thereafter, the substrate 32, including the first and/or second active layers 38, 40, may be held at room temperature and exposed to a subatmospheric pressure environment for a time in the range of 3 hours to 12 hours to remove residual volatile compounds (e.g., water) therefrom. In one specific example, the substrate 32, including the first and/or second active layers 38, 40, may be held at room temperature and exposed to a subatmospheric pressure environment for 3 hours prior to being incorporated into the electrochemical cell 10. In some instances, the slurry may be applied to the first or second side 34, 36 of the substrate 32 and dried, and then the slurry may be applied to the opposite side 34, 36 of the substrate 32 and dried prior to exposing the substrate and the layers 38, 40 to the subatmospheric pressure environment.

After the first and/or second active layers 38, 40 are dried, the layers 38, 40 may have thicknesses in the range of 2 μm to 20 μm. In one specific example, the active layers 38, 40 may have thicknesses in the range of 4 μm to 6 μm. As compared to the thickness of the substrate 32, the thickness of either of the active layers 38, 40 may be less than that of the substrate 32. More specifically, the thickness of either of the active layers 38, 40 may be 50% or less than the thickness of the substrate 32.

The particles of the lithium ion-exchanged zeolite material may comprise or consist essentially of particles of one or more dehydrated natural or synthetic zeolite materials. Zeolites are microporous crystalline aluminosilicate materials comprising a three-dimensional framework of AlO₂ and SiO₂ tetrahedral units and extra-framework cations. Each AlO₂ unit introduces one negative charge to the framework, which is offset by the extra-framework cations. The extra-framework cations may be organic or inorganic in nature. The presently disclosed lithium ion-exchanged zeolite material may comprise a three-dimensional framework of AlO₂ and SiO₂ tetrahedral units and extra-framework lithium cations (Lit). The amount of extra-framework lithium cations present in the lithium ion-exchanged zeolite material will at least partially depend on the Si:Al ratio of the specific zeolite material and the cation exchange capacity (CEC) of the zeolite material. In the presently disclosed lithium ion-exchanged zeolite material, lithium cations (Li⁺) may comprise greater than 90% of the extra-framework cations in the zeolite material, greater than 95% of the extra-framework cations, or greater than 99% of the extra-framework cations. Prior to operation of the electrochemical cell 10, the particles of the lithium ion-exchanged zeolite material may be substantially free of any and/or all of the following extra-framework cations: Na⁺ and H⁺.

The particles of the lithium ion-exchanged zeolite material may have a mean particle diameter in the range of 5 nm to 10 μm. In one form, the particles may have a mean particle diameter in the range of 100 nm to 1 μm.

Zeolite materials may be categorized based upon the crystalline structure of their corner-sharing network of tetrahedrally coordinated atoms or T-atoms (e.g., Si and Al). Zeolite structures are typically described or defined by reference to a framework type code consisting of three capital letters and assigned by the International Zeolite Association (“IZA”). A listing of all framework type codes assigned by the IZA can be found in the Atlas of Zeolite Framework Types, Sixth Revised Edition, Elsevier (2007).

In some embodiments, the particles of the lithium ion-exchanged zeolite material may comprise particles of a dehydrated zeolite material having an Si:Al ratio in the range of 1:1 to 5:1. Some examples of low silica zeolite framework types exhibiting an Si:Al ratio in the range of 1:1 to 2:1 include: ABW, AFG, ANA, BIK, CAN, EDI, FAU, FRA, GIS, GME, JBW, LAU, LEV, LIO, LOS, LTA, LTN, NAT, PAR, PHI, ROG, SOD, WEN, THO, and TSC. Some examples of zeolite framework types exhibiting an Si:Al ratio in the range of 2:1 to 5:1 include: BHP, BOG, BRE, CAS, CHA, CHI, DAC, EAB, EMT, EPI, ERI, FAU, FER, GOO, HEU, KFI, LOV, LTA, LTL, MAZ, MEI, MER, MON, MOR, OFF, PAU, RHO, SOD, STI, and YUG. In another form, the lithiated zeolite particles may have an Si:Al ratio greater than 5:1. Some examples of high silica zeolite framework types exhibiting an Si:Al ratio greater than 5:1 include: ASV, BEA, CFI, CON, DDR, DOH, DON, ESV, EUO, FER, GON, IFR, ISV, ITE, LEV, MEL, MEP, MFI, MFS, MSO, MTF, MTN, MTT, MTW, MWW, NON, NES, RSN, RTE, RTH, RUT, SFE, SFF, SGT, SOD, STF, STT, TER, TON, VET, VNI, and VSV.

The particles of the lithium ion-exchanged zeolite material may be prepared by a process that includes the following general steps: (1) obtaining a suitable amount of a microporous zeolite material in powder form and having exchangeable extra-framework cations, (2) contacting the zeolite material with a solution comprising at least one lithium salt dissolved in a solvent at a sufficient temperature and for a sufficient amount of time for at least some of the exchangeable extra-framework cations within the zeolite material to be replaced or exchanged with lithium ions to produce a lithium ion-exchanged zeolite material, (3) separating the lithium ion-exchanged zeolite material from the solvent, and (4) heat treating the lithium ion-exchanged zeolite material at a temperature greater than about 400° C. to release adsorbed water therefrom.

The microporous zeolite material may have as initial exchangeable cations one or more hydrogen-containing ions or ions of an alkali metal or an alkaline earth metal. In particular, the microporous zeolite material may have as initial exchangeable cations one or more ions of hydrogen, ammonia, lithium, sodium, potassium, rubidium, cesium, francium, beryllium, magnesium, calcium, strontium, barium, and radium. The zeolite material may be contacted by an aqueous or non-aqueous solution of a lithium salt, which may be at a temperature of greater than 50° C. during the ion-exchange process. The lithium salt may comprise lithium hydroxide, lithium carbonate, lithium chloride, lithium nitrate, lithium sulfate, or a combination thereof. The concentration of the lithium salt in the solution may be in the range of 0.1 M to 2 M and may be adjusted during the lithium ion-exchange treatment process to ensure a sufficient amount of the initial exchangeable cations in the zeolite material are replaced with lithium ions. The lithium ion-exchanged zeolite material may be separated from the solvent after ion exchange is complete by any suitable method, for example, by centrifuge. The lithium ion-exchanged zeolite material may be cleaned by removing residual ions and solvent therefrom, for example, by being washed with deionized water. Thereafter, the lithium ion-exchanged zeolite material may be calcined by being heated at a temperature greater than about 100° C. for a sufficient time to remove adsorbed water therefrom. The lithium ion-exchanged zeolite material may be calcined in a dry environment or in a vacuum to accelerate the water removal process. For example, the lithium ion-exchanged zeolite material may be calcined in an environment having less than 20% relative humidity, or in an environment as dry as possible. In one form, the lithium ion-exchanged zeolite material may be calcined by being heated at a temperature in the range of 400-600° C. for a time between 1 to 5 hours. In one specific example, the lithium ion-exchanged zeolite material may be calcined by being heated at a temperature of 450° C. for about 2 hours.

Atmospheric moisture may be readily absorbed by the particles of the lithium ion-exchanged zeolite material after calcination. Therefore, to avoid introducing water into the electrochemical cell 10 along with the particles of the lithium ion-exchanged zeolite material, care should be taken to avoid exposing the particles to atmospheric moisture after the calcination step is complete, prior to and during assembly of the cell 10. For example, prior to incorporating the particles of the lithium ion-exchanged zeolite material in the electrochemical cell 10, the particles may be transferred from the calcination step and stored in a dry environment. If the particles of the lithium ion-exchanged zeolite material are exposed to water, including atmospheric moisture, at any point prior to assembly of the electrochemical cell 10, an additional heat treatment step may be performed to eliminate trace water from the particles. The additional heat treatment step may be performed at a temperature greater than about 100° C. for a sufficient time to remove trace water from the particles of the lithium ion-exchanged zeolite material.

The particles of the lithium ion-exchanged zeolite material within the first active layer 38 and/or the second active layer 40 are positioned within a lithium ion transport path through the electrochemical cell 10. During operation of the electrochemical cell 10, lithium ions are communicated back and forth between the negative electrode layer 12 and the positive electrode layer 14 of the electrochemical cell 10, and the particles of the lithium ion-exchanged zeolite material are positioned such that, during this back and forth movement, the lithium ions necessarily encounter one or more of the particles of the lithium ion-exchanged zeolite material. The lithium ions may come into contact with or travel around or through the particles of the lithium ion-exchanged zeolite material during their movement through the electrochemical cell 10. The particles of the lithium ion-exchanged zeolite material are formulated to adsorb, scavenge, entrap or otherwise inhibit the movement of certain target compounds within the electrochemical cell 10, without adversely affecting the transport or net flow of lithium ions through the electrochemical cell 10. For example, the particles of the lithium ion-exchanged zeolite material may be formulated to entrap or inhibit the movement of water molecules, hydrogen ions, hydrofluoric acid (HF), and transition metal ions, such as Mn²⁺ and Fe^{2+/3+} ions, within the electrochemical cell 10. The target compounds may be entrapped within the particles of the lithium ion-exchanged zeolite material either physically, chemically, or both physically and chemically.

As such, including the particles of the lithium ion-exchanged zeolite material within the first and/or second active layers 38, 40 can help prevent a phenomenon referred to as “voltage droop,” reduce capacity fade and impedance, improve Coulombic efficiency, help maintain uniform current distribution along the electrode/electrolyte interface, reduce corrosion, and prevent outgassing of the cell 10.

Without intending to be bound by theory, it is believed that the particles of the lithium ion-exchanged zeolite material may help improve the cycle performance of the electrochemical cell 10, for example, by trapping trace water and scavenging hydrofluoric acid (HF). Immobilizing trace water molecules within the electrochemical cell 10 may help prevent decomposition of the liquid electrolyte 18, which in turn may help prevent decomposition of the lithium-based intercalation host material of the positive electrode layer 14. Hydrofluoric acid is highly corrosive and may be generated in the electrochemical cell 10 during decomposition of the electrolyte, in particular, by reaction of LiPF₆ with water according to the following reaction:

LiPF₆+H₂O↔LiF+POF₃+2HF (1)

The as-produced HF may increase the acidity of the electrolyte 18, which may lead to corrosion of the lithium-based intercalation host material of the positive electrode layer 14 and/or the current collectors 20, 22. Therefore, by functioning as an HF scavenger, the particles of the lithium ion-exchanged zeolite material within the first and/or second active layers 38, 40 may help reduce corrosion and degradation of the various components of the cell 10.

Furthermore, it is believed that the particles of the lithium ion-exchanged zeolite material within the first and/or second active layers 38, 40 may help improve the cycle performance of the electrochemical cell 10 by trapping transition metal ions, such as Mn²⁺ and Fe^{2+/3+} ions, which may be present in the liquid electrolyte 18 due to decomposition of the lithium-based intercalation host material of the positive electrode layer 14 and/or due to the presence of transition metal impurities in the positive electrode layer 14. Also, the particles of the lithium ion-exchanged zeolite material within the first and/or second active layers 38, 40 on the substrate 32 may help improve the robustness of the cell 10, for example, by improving the mechanical properties and thermal stability of the separator 16.

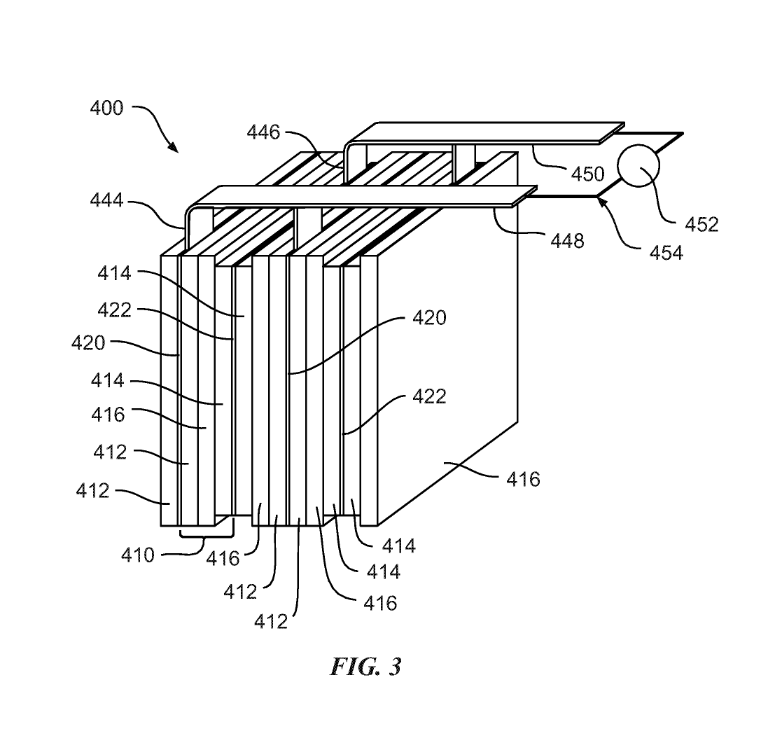

Referring now to FIG. 3, the electrochemical cell 10 may be combined with one or more other electrochemical cells to produce a lithium ion battery 400. The lithium ion battery 400 illustrated in FIG. 3 includes multiple rectangular-shaped electrochemical cells 410. Anywhere from 5 to 150 electrochemical cells 410 may be stacked side-by-side in a modular configuration and connected in series or parallel to form a lithium ion battery 400, for example, for use in a vehicle powertrain. The lithium ion battery 400 can be further connected serially or in parallel to other similarly constructed lithium ion batteries to form a lithium ion battery pack that exhibits the voltage and current capacity demanded for a particular application, e.g., for a vehicle. It should be understood the lithium ion battery 400 shown in FIG. 3 is only a schematic illustration, and is not intended to inform the relative sizes of the components of any of the electrochemical cells 410 or to limit the wide variety of structural configurations a lithium ion battery 400 may assume. Various structural modifications to the lithium ion battery 400 shown in FIG. 3 are possible despite what is explicitly illustrated.

Each electrochemical cell 410 includes a negative electrode 412, a positive electrode 414, and a separator 416 situated between the two electrodes 412, 414. Each of the negative electrode 412, the positive electrode 414, and the separator 416 is impregnated, infiltrated, or wetted with a liquid electrolyte capable of communicating lithium ions. A negative electrode current collector 420 that includes a negative polarity tab 444 is located between the negative electrodes 412 of adjacent electrochemical cells 410. Likewise, a positive electrode current collector 422 that includes a positive polarity tab 446 is located between neighboring positive electrodes 414. The negative polarity tab 444 is electrically coupled to a negative terminal 448 and the positive polarity tab 446 is electrically coupled to a positive terminal 450. An applied compressive force usually presses the current collectors 420, 422, against the electrodes 412, 414 and the electrodes 412, 414 against the separator 416 to achieve intimate interfacial contact between the several contacting components of each electrochemical cell 410.

One or more of the separators 416 may comprise a composite microporous separator, like the separator layer 16 depicted in FIGS. 1 and 2. In such case, the one or more separators 416 each may include a porous substrate having an active layer formed on one or both of its first and/or second sides, with each of the active layer(s) including particles of a lithium ion-exchanged zeolite material.

In the embodiment depicted in FIG. 3, the battery 400 includes two pairs of positive and negative electrodes 412, 414. In other embodiments, the battery 400 may include more than two pairs of positive and negative electrodes 412, 414. In one form, the battery 400 may include 15-60 pairs of positive and negative electrodes 412, 414. In addition, although the battery 400 depicted in FIG. 3 is made up of a plurality of discrete electrodes 412, 414 and separators 416, other arrangements are certainly possible. For example, instead of discrete separators 416, the positive and negative electrodes 412, 414 may be separated from one another by winding or interweaving a single continuous separator sheet between the positive and negative electrodes 412, 414. In another example, the battery 400 may include continuous and sequentially stacked positive electrode, separator, and negative electrode sheets folded or rolled together to form a “jelly roll.”

The negative and positive terminals 448, 450 of the lithium ion battery 400 are connected to an electrical device 452 as part of an interruptible circuit 454 established between the negative electrodes 412 and the positive electrodes 414 of the many electrochemical cells 410. The electrical device 452 may comprise an electrical load or power-generating device. An electrical load is a power-consuming device that is powered fully or partially by the lithium ion battery 400. Conversely, a power-generating device is one that charges or re-powers the lithium ion battery 400 through an applied external voltage. The electrical load and the power-generating device can be the same device in some instances. For example, the electrical device 452 may be an electric motor for a hybrid electric vehicle or an extended range electric vehicle that is designed to draw an electric current from the lithium ion battery 400 during acceleration and provide a regenerative electric current to the lithium ion battery 400 during deceleration. The electrical load and the power-generating device can also be different devices. For example, the electrical load may be an electric motor for a hybrid electric vehicle or an extended range electric vehicle and the power-generating device may be an AC wall outlet, an internal combustion engine, and/or a vehicle alternator.

The lithium ion battery 400 can provide a useful electrical current to the electrical device 452 by way of the reversible electrochemical reactions that occur in the electrochemical cells 410 when the interruptible circuit 454 is closed to connect the negative terminal 448 and the positive terminal 450 at a time when the negative electrodes 412 contain a sufficient quantity of intercalated lithium (i.e., during discharge). When the negative electrodes 412 are depleted of intercalated lithium and the capacity of the electrochemical cells 410 is spent. The lithium ion battery 400 can be charged or re-powered by applying an external voltage originating from the electrical device 452 to the electrochemical cells 410 to reverse the electrochemical reactions that occurred during discharge.

Although not depicted in the drawings, the lithium ion battery 400 may include a wide range of other components. For example, the lithium ion battery 400 may include a casing, gaskets, terminal caps, and any other desirable components or materials that may be situated between or around the electrochemical cells 410 for performance related or other practical purposes. For example, the lithium ion battery 400 may be enclosed within a case (not shown). The case may comprise a metal, such as aluminum or steel, or the case may comprise a film pouch material with multiple layers of lamination. In one form, lithiated zeolite particles may be disposed on a surface of the case for the lithium ion battery 400 (not shown).

### EXAMPLES

Three porous separators were obtained or prepared and used in electrochemical cells of a lithium ion battery and the cycle performance of the as-prepared electrochemical cells was evaluated.

The electrochemical cells each included a nickel-rich lithium-nickel-manganese-cobalt oxide (NMC) positive electrode material, a graphite (G) negative electrode material, and a non-aqueous liquid electrolyte solution. The chemical composition of the NMC positive electrode material can be represented by the following chemical formula: Li(Ni_{0.6}Co_{0.2}Mn_{0.2})O₂ (NMC622). The non-aqueous liquid electrolyte solution included 1.0 M LiPF₆ in a mixture of ethylene carbonate (EC) and diethyl carbonate (DEC) at an EC:DEC ratio of 1:2 wt. % (LiPF₆/EC/DEC).

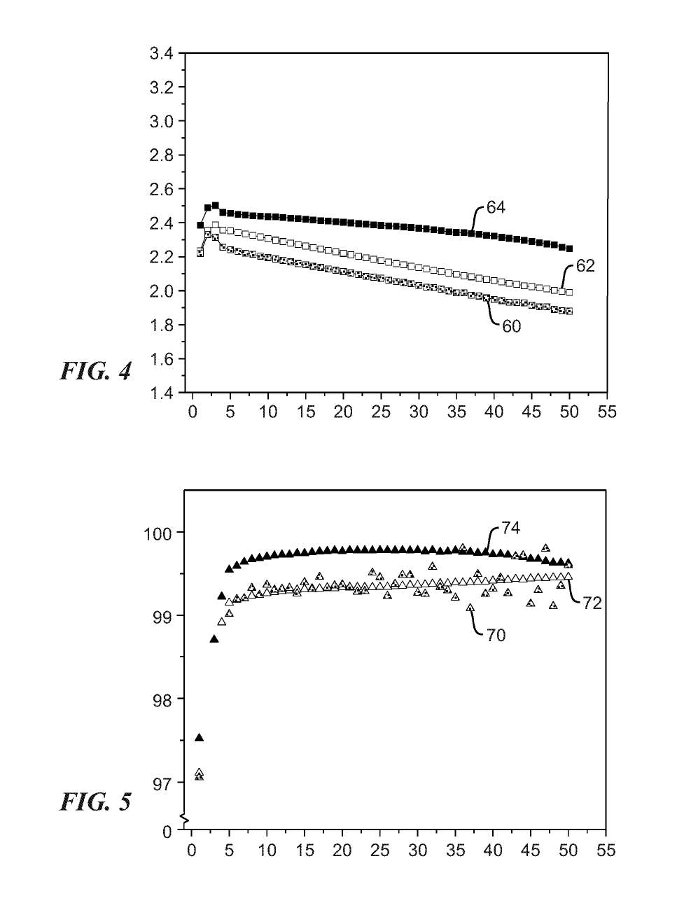

The cycle performance of the electrochemical cells was evaluated under accelerated testing conditions. Specifically, the electrochemical cells were cycled 50 times at a temperature of about 50° C. using an initial charge rate of C/20 (using the standard C rate definition) for three cycles, followed by a charge rate of C/6 for the remaining number of cycles. Prior to testing the as-prepared electrochemical cells were held at a temperature of about 50° C. for 6 hours. FIG. 4 depicts the Specific Capacity (mAh/cm²) vs. Cycle Number for each of the as-prepared electrochemical cells, and FIG. 5 depicts the Coulombic Efficiency (%) vs. Cycle Number for each of the as-prepared electrochemical cells.

### Example 1

An electrochemical cell for a lithium ion battery was prepared including the NMC622 positive electrode material, the graphite negative electrode material, a 16 μm thick composite microporous separator manufactured by MTI Corporation, and the LiPF₆/EC/DEC electrolyte solution. The MTI separator included a 12 μm thick polyethylene substrate with 2 μm thick alumina (Al₂O₃) coatings on both sides of the substrate.

As shown in FIG. 4, the specific capacity of this electrochemical cell including the MTI separator (60) gradually decreased as the number of cycles increased. In particular, after the first cycle the electrochemical cell exhibited a specific capacity of about 2.32 mAh/cm². After 50 cycles, the electrochemical cell exhibited a specific capacity of less than about 1.9 mAh/cm². As shown in FIG. 5, the Coulombic efficiency of the electrochemical cell (70) varied unpredictably between about 97% and 99.7% during each cycle of the test.

### Example 2

An electrochemical cell for a lithium ion battery was prepared including the NMC622 positive electrode material, the graphite negative electrode material, a 20 μm thick microporous polymeric separator manufactured by Celgard, and the LiPF₆/EC/DEC electrolyte solution. The Celgard separator exhibited a trilayer structure including polypropylene and polyethylene (PP/PE/PP) (Celgard 2320).

As shown in FIG. 4, the specific capacity of the electrochemical cell including the Celgard separator (62) gradually decreased as the number of cycles increased. In particular, after three (3) cycles, the electrochemical cell exhibited a specific capacity of about 2.39 mAh/cm². After 50 cycles, the electrochemical cell exhibited a specific capacity of less than 2.0 mAh/cm². As shown in FIG. 5, the Coulombic efficiency of the electrochemical cell (72) was below 99.5% for all cycles of the test.

### Example 3

An electrochemical cell for a lithium ion battery was prepared including the NMC622 positive electrode material, the graphite negative electrode material, a 60 μm thick composite microporous separator including particles of a lithium ion-exchanged zeolite material, and the LiPF₆/EC/DEC electrolyte solution.

Particles of the lithium ion-exchanged zeolite material were prepared from a synthetic zeolite material referred to as ZSM-5. The ZSM-5 zeolite material was obtained in sodium form (Na-ZSM-5) and mixed with an aqueous lithium hydroxide (LiOH) solution at a temperature of about 80° C. for about 12 hours to exchange the extra-framework sodium ions (Nat) in the zeolite material with lithium ions (Lit) to produce a lithiated form of ZSM-5 (Li-ZSM-5). The solid Li-ZSM-5 particles were separated from the aqueous solution by centrifuge and washed with deionized water at least 5 times. Thereafter, the Li-ZSM-5 powder was calcined at a temperature of about 450° C. for 2 hours to remove adsorbed water therefrom. After calcination, the Li-ZSM-5 powder had a mean particle diameter of 3 μm.

The Li-ZSM-5 powder was mixed with a binder to form a slurry, which was then coated on both sides of a 20 μm thick microporous polymeric separator manufactured by Celgard. The Celgard separator exhibited a trilayer structure including polypropylene and polyethylene (PP/PE/PP) (Celgard 2320).

A two-component polymeric binder system was used to prepare the slurry. Component A of the two-component polymeric binder system had a composition that included a water-soluble cellulose-based polymer, and component B had a composition that included a crosslinking or curing agent. First, component A was diluted by addition of deionized water to produce a dilute solution of component A. The dilute solution of component A included about 3 wt. % to about 10 wt. % of the water-soluble cellulose-based polymer and was mixed in a homogenizer (VWR 200) at 5000 rpm for 15 minutes. Then, a desired amount of the Li-ZSM-5 powder was added to the dilute solution and mixed in the homogenizer for another 15 minutes. Thereafter, component B of the two-component binder system was added to the Li-ZSM-5 powder-containing solution and mixed in the homogenizer for another 15 minutes to form a slurry. The mass ratio of component A to component B in the as-prepared slurry was 9:1. The as-prepared slurry included about 20 wt. % Li-ZSM-5 particles and had a viscosity in the range of 400-1200 mPa·s.

The Li-ZSM-5 particle-containing slurry was spread onto one side of the Celgard separator using a mini-coating machine (MC-20, Hohsen) at a speed of 5 millimeters per second. Then, the Li-ZSM-5 particle-coated separator was dried in an oven at 80° C. for 3 minutes. Thereafter, the Li-ZSM-5 particle-containing slurry was spread onto an opposite side of the Celgard separator and dried in an oven at 80° C. for 3 minutes to produce a composite microporous separator including a 20 μm thick PP/PE/PP substrate having opposite first and second sides coated with 20 μm thick Li-ZSM-5 particle-containing microporous coating layers. The composite microporous separator was further dried at room temperature under a subatmospheric pressure environment (i.e., at a pressure of about 10⁻⁵ Pa) for 3 hours prior to being incorporated into the electrochemical cell.

As shown in FIG. 4, the specific capacity of the electrochemical cell including the Li-ZSM-5 particle-coated composite microporous separator (64) gradually decreased as the number of cycles increased. In particular, after three (3) cycles the electrochemical cell exhibited a specific capacity of about 2.5 mAh/cm². After 50 cycles, the electrochemical cell exhibited a specific capacity of about 2.25 mAh/cm². As shown in FIG. 5, the Coulombic efficiency of the electrochemical cell (74) was above 99.5% for all cycles of the test.

Accordingly, forming an electrochemical cell of a lithium ion battery with a composite microporous separator that includes a PP/PE/PP substrate and Li-ZSM-5 particle-containing coatings on opposite sides thereof can effectively reduce capacity fade and improve the Coulombic efficiency of the cell.

The above description of preferred exemplary embodiments, aspects, and specific examples are merely descriptive in nature; they are not intended to limit the scope of the claims that follow. Each of the terms used in the appended claims should be given its ordinary and customary meaning unless specifically and unambiguously stated otherwise in the specification.

What is claimed is:

1. A method for manufacturing a composite porous separator for an electrochemical cell of a secondary lithium ion battery, the method comprising:
preparing a slurry comprising particles of a lithium ion-exchanged zeolite material and a polymeric binder material;
providing a porous substrate having a first side and an opposite second side;
depositing a layer of the slurry on the first or second side of the substrate; and
drying the slurry on the first or second side of the substrate to form a solid microporous active layer on the first or second side of the substrate.

2. The method set forth in claim 1 wherein the porous substrate comprises a microporous polyolefin-based membrane.

3. The method set forth in claim 1 wherein the polymeric binder material is formed from a two-component polymeric binder system including a polymer precursor component and a crosslinking component.

4. The method set forth in claim 3 wherein the polymer precursor component comprises at least one polymer or polymer precursor selected from the group consisting of:
sodium ammonium alginate, polyvinyl alcohol, polyacrylic acid, carboxymethyl cellulose, styrene-butadiene rubber, fluorine-acrylic hybrid latex, and combinations thereof.

5. The method set forth in claim 3 wherein the crosslinking component comprises at least one of the following: dimethylol urea, melamine formaldehyde resin, polyamide-epichlorohydrin (PAE) resin, N-(1-hydroxy-2,2-dimethoxyethyl)acrylamide, N,N′-methylenebisacrylamide, ethylene glycol dimethacrylate, and combinations thereof.

6. The method set forth in claim 1 wherein the particles of the lithium ion-exchanged zeolite material are present in the slurry in an amount in the range of 10-30 wt. %.

7. The method set forth in claim 1 wherein the polymeric binder material is present in the slurry in an amount in the range of 1.5-8 wt. %.

8. The method set forth in claim 1 wherein the slurry is dried by heating the substrate at a temperature in the range of 30° C. to 140° C. and for a time in the range of 3 minutes to 2 hours.

9. The method set forth in claim 1 wherein the slurry has a viscosity in the range 400-1200 mPa·s when the slurry is deposited on the first or second side of the substrate.

10. The method set forth in claim 1 wherein the particles of the lithium ion-exchanged zeolite material comprise particles of a dehydrated zeolite material exhibiting an Si:Al ratio in the range of 1:1 to 2:1 and having a framework type selected from the group consisting of: ABW, AFG, ANA, BIK, CAN, EDI, FAU, FRA, GIS, GME, JBW, LAU, LEV, LIO, LOS, LTA, LTN, NAT, PAR, PHI, ROG, SOD, WEN, THO, and TSC.

11. The method set forth in claim 1 wherein the particles of the lithium ion-exchanged zeolite material comprise particles of a dehydrated zeolite material exhibiting an Si:Al ratio in the range of 2:1 to 5:1 and having a framework type selected from the group consisting of: BHP, BOG, BRE, CAS, CHA, CHI, DAC, EAB, EMT, EPI, ERI, FAU, FER, GOO, HEU, KFI, LOV, LTA, LTL, MAZ, MEI, MER, MON, MOR, OFF, PAU, RHO, SOD, STI, and YUG.

12. The method set forth in claim 1 wherein the particles of the lithium ion-exchanged zeolite material comprise particles of a dehydrated zeolite material exhibiting an Si:Al ratio of greater than 5:1 and having a framework type selected from the group consisting of: ASV, BEA, CFI, CON, DDR, DOH, DON, ESV, EUO, FER, GON, IFR, ISV, ITE, LEV, MEL, MEP, MFI, MFS, MSO, MTF, MTN, MTT, MTW, MWW, NON, NES, RSN, RTE, RTH, RUT, SFE, SFF, SGT, SOD, STF, STT, TER, TON, VET, VNI, and VSV.

13. An electrochemical cell for a secondary lithium ion battery comprising:
a negative electrode layer;
a positive electrode layer spaced apart from the negative electrode layer;
a composite porous separator layer disposed between confronting surfaces of the negative electrode layer and the positive electrode layer; and
a liquid electrolyte infiltrating the negative electrode layer, the positive electrode layer, and the porous separator layer,
wherein the composite porous separator layer comprises a porous substrate and a solid microporous active layer including particles of a lithium ion-exchanged zeolite material formed on at least one side of the porous substrate.

14. The electrochemical cell set forth in claim 13 wherein the porous substrate includes a first side that faces toward the negative electrode layer and an opposite second side that faces toward the positive electrode layer, and wherein the solid microporous active layer is formed on the first or second side of the porous substrate.

15. The electrochemical cell set forth in claim 13 wherein the porous substrate includes a first side that faces toward the negative electrode layer and an opposite second side that faces toward the positive electrode layer, and wherein a first solid microporous active layer is formed on the first side of the porous substrate and a second solid microporous active layer is formed on the second side of the porous substrate.

16. The electrochemical cell set forth in claim 13 wherein the particles of the lithium ion-exchanged zeolite material are present in the solid microporous active layer in an amount in the range of 20-95 wt. %.

17. A secondary lithium ion battery including a plurality of the electrochemical cells set forth in claim 13, wherein the electrochemical cells are connected in a series or parallel arrangement.
